(19) United States
(12) Patent Application Publication
(10) Pub. No.: US 2022/0007113 A1
(43) Pub. Date: Jan. 6, 2022

(54) REINFORCING PART FOR DIAPHRAGM OF SPEAKER, AND THE DIAPHRAGM

(71) Applicant: Goertek Inc., Weifang, Shandong (CN)

(72) Inventors: Yong Li, Shandong (CN); Cuili Zhang, Shandong (CN)

(73) Assignee: Goertek Inc., Weifang, Shandong (CN)

(21) Appl. No.: 17/292,551

(22) PCT Filed: Dec. 20, 2018
(86) PCT No.: PCT/CN2018/122338

§ 371 Date: May 10, 2021

(30) Foreign Application Priority Data
Nov. 9, 2018 (CN) 201811331620.8

(51) Int. Cl. H04R 7/04; H04R 9/06; H04R 9/02

(52) U.S. Cl. CPC H04R 7/04; H04R 2207/021; H04R 9/022; H04R 9/06

(57) ABSTRACT

Disclosed are a reinforcing part for a speaker diaphragm, and the diaphragm. The reinforcing part is an overlapped multilayer structure, and includes a support layer and at least one heat dissipation layer fixed and bonded to a surface of at least one side of the support layer. The support layer includes through holes penetrating surfaces of two sides of the support layer. The reinforcing part further includes fillers located within the through holes and configured for heat conduction, the fillers having thermal conductivity higher than that of the support layer.

### CROSS-REFERENCE TO RELATED APPLICATIONS

This application is a National Stage of International Application No. PCT/CN2018/122338, filed on Dec. 20, 2018, which claims priority to Chinese Patent Application No. 201811331620.8, filed on Nov. 9, 2018, both of which are hereby incorporated by reference in their entireties.

### TECHNICAL HELD

The present disclosure relates to the field of electro-acoustic technology. More specifically, it relates to a reinforcing part structure for a diaphragm of a speaker, as well as the diaphragm and the speaker to which the reinforcing part structure is applied.

### BACKGROUND

A speaker, as a component which can convert electrical energy into sound, is widely used in electronic terminal devices such as mobile phones, tablet computers, notebooks, PDAs. A speaker structure typically includes a magnetic circuit system, a vibration system and an auxiliary system, wherein the vibration system essentially includes a diaphragm and a voice coil. When the speaker is in operation, the voice coil generates a lot of heat which cannot be easily dissipated to the outside, since the voice coil is located in a rear acoustic cavity of the speaker which is relatively closed.

Since a front acoustic cavity of the speaker is in communication with the outside through sound holes, a prior art speaker is typically provided with a reinforcing part (a DOME, also called an overlapping part) on the diaphragm, in order to enhance the performance of the high-frequency position of the product. Therefore, through the reinforcing part structure, the heat generated by the voice coil may be conducted from the rear acoustic cavity to the front acoustic cavity, and in turn the heat is dissipated to the outside through the air flow between the front acoustic cavity and the outside, thereby realizing heat dissipation from the speaker.

A prior art reinforcing part structure is typically made of a resin composite material, a metal material, or a composite material of metal and resin; however, such reinforcing part structure has a low thermal conductivity and a poor heat conduction performance, and thus cannot meet the heat dissipation requirements of a micro speaker. Therefore, there is a need to provide a new reinforcing part structure with an excellent performance of heat conduction.

### SUMMARY

An objective of the present invention is to provide a reinforcing part with a high thermal conductivity.

According to an aspect of the invention, a reinforcing part for a speaker diaphragm is provided, the reinforcing part being an overlapped multilayer structure, the reinforcing part includes a support layer and at least one heat dissipation layer fixed and bonded to a surface of at least one side of the support layer, and the support layer includes through holes penetrating surfaces of two sides of the support layer, and the reinforcing part further includes fillers located within the through holes and configured for heat conduction, the fillers having thermal conductivity higher than that of the support layer.

Preferably, the surface of one side of the support layer is fixed and bonded to one, two or even more heat dissipation layers.

Preferably, the surfaces of two side surfaces of the support layer are fixed and bonded to one, two or even more heat dissipation layers, respectively; and wherein the heat dissipation layers respectively fixed and bonded to the surfaces of the two side surfaces of the support layer are of the same quantity or of different quantities.

Preferably, the support layer includes a plurality of through holes penetrating surfaces of two sides of the support layer and evenly distributed on the support layer.

Preferably, the through holes are located within an area covered by the heat dissipation layer, and end surfaces of the fillers are fitted and fixed to a surface of the heat dissipation layer.

Preferably, sidewall surfaces of the fillers are bonded and fixed to inner walls of the through holes by adhering; or the sidewall surfaces of the filler are fitted and fixed to the inner walls of the through holes by interference fit.

Preferably, the thermal conductivity of each heat dissipation layer is greater than that of the support layer.

Preferably, the support layer is made of carbon fiber, resin or steel, the support layer is made of carbon fiber, resin or steel; the fillers are made of graphene, copper or aluminum; the first heat dissipation layer is made of graphene, copper or aluminum; and the second heat dissipation layer is made of graphene, copper or aluminum.

Preferably, the heat dissipation layer and the fillers are made of the same material or different materials, or any two of them are made of the same material.

According to another aspect of the invention, a diaphragm is provided, and the diaphragm includes a fixing part, a corrugated rim integral with the fixing part, a central part located within the corrugated rim, and the above-mentioned reinforcing part for the speaker diaphragm, the reinforcing part being bonded and fixed to a surface of the central part.

The beneficial effects provided by the present invention are as follows:

The reinforcing part of the present invention improves the heat conduction capability between surfaces of two sides of the reinforcing part by providing through holes on the first support layer and the second support surface and providing heat-conducting fillers within the through holes. In a speaker adopting such a reinforcing part structure, heat may be quickly conducted from a rear acoustic cavity to a front acoustic cavity, and may be dissipated outward through the air flow between the front acoustic cavity and the outside, thereby realizing quick heat dissipation from the speaker.

### BRIEF DESCRIPTION OF THE DRAWINGS

The specific implementations of the present invention are described below in further detail with reference to the accompanying drawings.

FIG. 1 shows a schematic, exploded structural diagram of a reinforcing pail according to the present invention.

FIG. 2 shows a schematic, exploded structural diagram of a diaphragm according td the present invention.

FIG. 3 shows a schematic, exploded structural diagram of a vibration system of a speaker according o the present invention

### DETAILED DESCRIPTION

To explain the present invention more clearly, the present invention will be further described below with reference to preferred embodiments and the accompanying drawings. Similar parts are represented by the same reference numerals in the drawings. Those skilled in the art should understand that the following detailed embodiments are illustrative rather than restrictive, and should not be interpreted as limitation to the protection scope of the present invention.

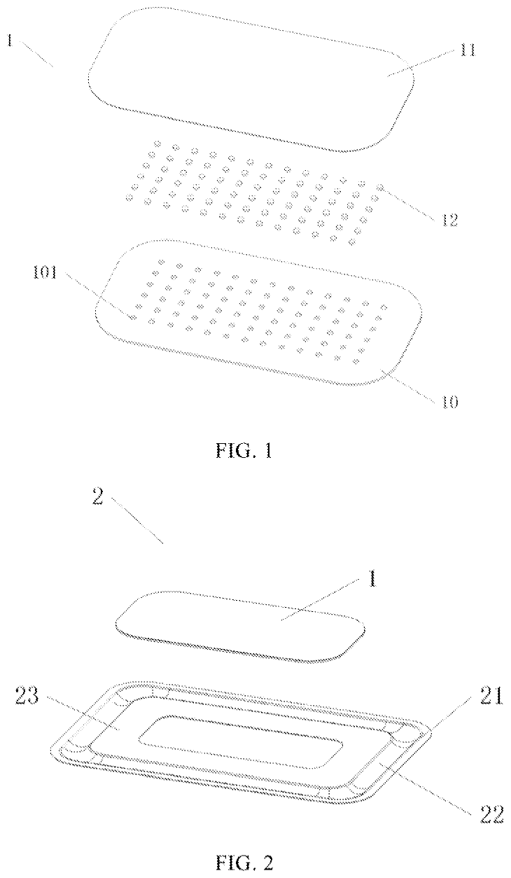

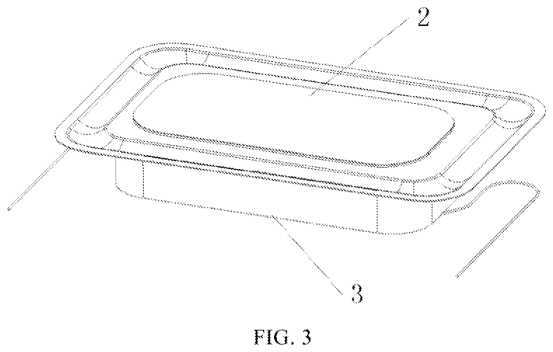

As shown to FIG. 1 the present invention provides a reinforcing part 1 for a diaphragm, wherein the shape of the reinforcing part is not limited and depends on practical application, such as circular, rectangular, elliptical, etc.; the reinforcing part 1 is made into the shape of a plate, a sphere, etc. according to practical n ds, and is overlapped on the diaphragm for direct use. The reinforcing part 1 includes a support layer 10 and a heat dissipation layer 11 fixed and bonded to a surface of one side of the support layer 10. The material of the support layer 10 is selected from one of metal, resin or carbon fiber. Then, an appropriate process is selected according to the respective selected material of the support layer 10, so that the support layer may be made into thin plate shape. The dissipation layer 11 may be made of a material selected from one of graphene, copper or aluminum, then be made into a thin plate based on the respective selected material, and then fixed and connected to a surface of one side of the support layer 10, so that the reinforcing part 1 is formed into an overlapped multilayer structure. The heat dissipation layer 11 may be fixed and connected o either side of the support layer 10, or fixed and bonded to surfaces of both sides of the support layer 10 at the same time. In addition, an additional heat dissipation layer may he fixed and bonded on the heat dissipation layer 11 to further improve the heat dissipation capability. The material of the heat dissipation layer 11 has a thermal conductivity greater than that of the support layer 10. Specifically, the material of the heat dissipation layer 11 in this embodiment is copper, and the material of the support layer 10 is steel. Since the rigidity of the steel sheet is much greater than. that of the copper sheet, the steel sheet may provide support for the copper sheet. The support layer 10 and the heat dissipation layer 11 may be fixedly connected by adhering.

The thermal conductivity of the heat dissipation layer 11 located on one side of the support layer 10 is greater than that of the support layer 10. In order to improve the heat transfer efficiency between the two sides of the support layer 10, the support layer 10 of the present invention includes through holes 101 penetrating the two side surfaces, and a filler 12 is arranged in each through hole 101 and the thermal conductivity of the filler 12 is greater than that of the support layer 10. The through holes 101 are located within the area covered by the heat dissipation layer 11, and one end of the filler 12 is fitted to the heat dissipation layer 11. Since the thermal conductivity of the filler 12 is greater than that of the support layer 10, such a structure may improve the heat conduction between the two sides of the support layer 10, thereby improving overall heat conduction capability of the reinforcing part of the overlapped layer structure.

Further, the material of the fillers 12 may be selected from one of graphene, copper or aluminum, and the fillers 12 and the heat dissipation layer 11 may be made of the same material or different materials, and the shape of the fillers 12 may be powder or other granular solid shapes. In this embodiment, the fillers 12 are copper particles, which are located within the through holes 101 of the steel sheet, and each of the copper particles has one end fitted to the copper sheet.

The outer side surface of the filler 12 and the inner wall of the through hole 101 are fitted to each other. Preferably, a side wall surface of the filler 12 is bonded and fixed to an inner wall of the through hole 101 by adhering; or the side wall surface of the filler 12 are fitted and fixed to the inner wall of the through hole 101 by interference fit. This structure enhances the connection strength between the filler 12 and the support layer 10, thereby improving the reliability of the reinforcing part 1.

In another embodiment, the fillers 12 are in powdered form. In order to increase the connection strength between the powdered fillers 12 and the through holes 101, an adhesive may be mixed in the filler 1, and thus the fillers 12 are fixedly connected to the through holes 101.

Further, the support layer 10 includes a plurality of through holes 101 penetrating through surfaces of two sides thereof; and the plurality of through holes 101 are evenly distributed on the support layer 10. Each through hole is located within the area covered by the heat dissipation layer 11, and each through hole 101 is provided with a filler 12, so as to further improve the heat conduction capability between the two sides of the support layer 10.

The cross-sectional shapes of the through holes 101 provided on the support layer 10 may be circular, elliptical or rectangular, and may be selected by those skilled in the art according to practical need.

As shown in FIG. 2, the invention further provides a diaphragm 2, the diaphragm 2 includes a fixing part 21 being fixed to the sound generator housing, a corrugated rim 22 being integral with the fixing part 21, a central part 23 located within the corrugated rim 22, and a reinforcing part being bonded and fixed to the central part 23. The central part 23 is a hollowed-out structure, and the reinforcing part 1 is fixed arid bonded to the hollowed-out structure. Since the reinforcing part 1 is the aforementioned structure, it has a strong heat conduction capability between the two sides of the support layer 10, thereby improving the heat conduction capability between the two sides of the diaphragm.

The present invention also provides a speaker. The speaker includes a magnetic circuit system and a vibration system in cooperation with the magnetic circuit system. The vibration system includes the above-mentioned diaphragm 2 and a voice coil 3 fixed and bonded to a side of the diaphragm 2. In the speaker of the present invention, the heat generated by the voice coil 3 is conducted from the rear acoustic cavity to the front acoustic cavity by the diaphragm 2, and in turn is dissipated to the outside through the air flow between the front acoustic cavity and the outside. Since the diaphragm 2 has strong heat conductivity and may quickly dissipate the heat from the speaker, as such, the speaker of the present invention has a good heat dissipation capability and thereby improved operation reliability. Preferably, the heat dissipation layer 11 is fixed and bonded to a surface of one side of the diaphragm distal from the voice coil, which may improve the heat dissipation capacity of the diaphragm.

Obviously, the above-mentioned embodiments of the present invention are merely examples for dear illustration of the present invention, and. are not meant to limit the implementation of the present invention. For those of ordinary skill in the art, other changes or modifications may be made in various manners based on the foregoing description. Although it is not possible to list all the implementations here, any obvious changes or modifications derived from the technical solutions of the present invention still fall within the protection scope of the present invention.

1. A reinforcing part for a speaker diaphragm having an overlapped multilayer structure, wherein the reinforcing part comprises a support layer and at least one heat dissipation layer fixed and bonded to a surface of at least one side of the support layer, the support layer comprises a plurality of through holes penetrating surfaces of two sides of the support layer, and the reinforcing part further comprises a plurality of fillers, each located within one of the through holes and configured for heat conduction, the fillers having thermal conductivity higher than that of the support layer.

2. The reinforcing part for a speaker diaphragm of claim 1, wherein the surface of one side of the support layer is fixed and bonded to one or more heat dissipation layers.

3. The reinforcing part for a speaker diaphragm of claim 1, wherein the surfaces of two sides of the support layer are fixed and bonded to one or more heat dissipation layers respectively; and wherein
the heat dissipation layers respectively fixed and bonded to surfaces of the two sides of the support layer are of the sane quantity or of different quantities.

4. The reinforcing part for a speaker diaphragm of claim 1, wherein the support layer comprises a plurality of through holes penetrating surfaces of two sides of the support layer and evenly distributed on the support layer.

5. The reinforcing part for a speaker diaphragm of claim 1, wherein the through holes are located within an area covered by the at least one heat dissipation layer, and end surfaces of the fillers are fined and fixed to a surface of the heat dissipation layer.

6. The reinforcing part for a speaker diaphragm of claim 1, wherein sidewall surfaces of the fillers are selected form the group consisting of sidewall surfaces bonded and axed to inner walls of the through holes by an adhering and sidewall surfaces fitted and fixed to the inner walls of the through holes by an interference fit.

7. The reinforcing part for a speaker diaphragm of claim 1, wherein the thermal conductivity of each heat dissipation layer is greater than that of the support layer.

8. The reinforcing part for a speaker diaphragm of claim 1, wherein the at least one heat dissipation layer comprises a first heat dissipation layer and a second heat dissipation layer, and wherein:
the support layer is made of carbon. fiber, resin or steel;
the fillers are made of graphene, copper or aluminum;
the first heat dissipation layer is made of graphene, copper or aluminum; and
the second heat dissipation layer is made of grapheme, copper or aluminum.

9. The reinforcing part for a speaker diaphragm of claim 1, wherein the at least one heat dissipation layer and the fillers are made of the same material or different materials, or any two of them are made of the same material.

10. A diaphragm, comprising a fixing part, a corrugated rim integral with the fixing part, a central part located within the corrugated rim, and the reinforcing part for a speaker diaphragm according to claim 1, the reinforcing part being bonded and fixed to a surface of the central part.
